(19) United States
(12) Patent Application Publication
(10) Pub. No.: US 2007/0163948 A1
(43) Pub. Date: Jul. 19, 2007

(54) Oil strainer

(76) Inventor: Taisuke Sato, Shizuoka (JP)

Correspondence Address: WENDEROTH, LIND & PONACK, L.L.P., 2033 K STREET N. W., SUITE 800, WASHINGTON, DC, 20006-1021, US

(21) Appl. No.: 11/652,561

(22) Filed: Jan. 12, 2007

(30) Foreign Application Priority Data
Jan. 19, 2006 (JP) 2006-011511

(51) Int. Cl. B01D 35/00

(52) U.S. Cl. 210/455

(57) ABSTRACT

There is provided an oil strainer in which the assembling work can be performed very easily, and more over high quality can be ensured. An oil strainer 1 includes a housing 2 formed by closing an open portion 6 of a case body 3 by a cover body 20 and a filter element 30 disposed in the housing 2. In the case body 3, there is provided a groove portion 8 including a guide portion 9 for guiding the filter element 30 to the inside of the case body 3 by inserting both side edges of the filter element 30 into the inside and a locking portion 10 for locking the filter element 30 by inserting the tip end edge in the insertion direction of the filter element 30 into the inside.

### BACKGROUND OF THE INVENTION

1. Field of the Invention

The present invention relates to an oil strainer that is used for vehicles and industrial machinery to filter oil.

2. Description of the Related Art

An oil strainer is generally made up of a housing for allowing oil to flow therein and a filter element disposed in the housing. An oil strainer of a type in which the housing is formed of a resin material is widely known. In the case where the housing is formed of a resin material, the oil strainer is completed mainly by molding a plurality of components in advance and by setting a filter element between these components and welding the components to each other.

Patent Document 1 discloses one example of the conventional oil strainer. In this oil strainer, a pipe-form housing is formed by two resin-made components. At both ends in the axial direction of the housing, an inflow portion for allowing oil to be filtered to flow and an outflow portion for discharging the oil having been filtered are provided. A filter element is inserted through the inflow portion and is arranged in the housing, and the filter element is arranged so as to be held between the components.

Further, Patent Document 1 discloses an oil strainer in which the filter element and one component are formed as one member. In this oil strainer, the housing includes a tubular component formed with an open portion and a flat plate shaped component that closes the open portion. The filter element is provided on the inner surface of the flat plate shaped component so as to be at right angles to the flat plate shaped component, and the filter element and the flat plate shaped component are formed as one member.

In this oil strainer, on the inner surface of the tubular component, a locking portion for locking the tip end portion of the filter element is formed at a position facing to the open portion, and when both of the components are welded to each other, the tip end of the filter element is locked by the locking portion.

[Patent Document 1] Japanese Patent Laid-Open No. 8-121138

However, of the oil strainers disclosed in Patent Document 1, an oil strainer of a type in which the filter element is inserted has a disadvantage that the filter element may be damaged in the insertion process, and also the work for positioning the filter element is troublesome.

Also, in the oil strainer of a type in which the filter element is held between the two components, poor weld may occur unless the joint portion of the components is fabricated into a special shape in advance.

Further, in the oil strainer in which the filter element and one component are formed integrally, when the component formed integrally with the filter element is joined to the open portion formed in the tubular component, it is difficult to check whether the tip end of the filter element engages surely with the locking portion of the tubular component, so that it is difficult to perform the positioning work efficiently.

In the case where the housing is formed by a plurality of components and is formed by welding these components, it is very difficult to perform vibration welding unless the strength or rigidity of the component is made high in advance.

### SUMMARY OF THE INVENTION

Accordingly, an object of the present invention is to provide an oil strainer in which the assembling work can be performed very easily, and moreover high quality can be ensured.

To achieve the above object, the present invention provides an oil strainer including a housing (2, 51, 71) which is formed by a case body (3, 72) formed with an open portion (6, 85) and a cover body (20, 55, 90) which closes the open portion (6, 85) of the case body (3, 72), and allows oil to flow therein; a filter element (30, 60, 100) disposed in the housing (2, 51, 71) to filter oil flowing in the housing (2, 51, 71); and an inflow portion (15, 94) through which oil flows into the housing (2, 51, 71) and an outflow portion (16, 73) through which the oil having flown in the housing (2, 51, 71) flows out, wherein in the case body (3, 72), there is provided a groove portion (8, 80) including a guide portion (9, 81) for guiding the filter element (30, 60, 100) to the inside of the case body (3, 72) by inserting both side edges of the filter element (30, 60, 100) into the inside and a locking portion (10, 82) for locking the filter element (30, 60, 100) having been guided by the guide portion (9, 81) by inserting the tip end edge in the insertion direction of the filter element (30, 60, 100) into the inside; the groove portion (8, 80) is formed along the inner peripheral surface of the case body (3, 72) from one portion of a peripheral edge portion (6a, 86) of the open portion (6, 85) to the other portion thereof, and divides an interior of the case body (3, 72) into the dirty side (D) on which the inflow portion (15, 94) is disposed and the clean side (C) on which the outflow portion (16, 73) is disposed; and on the inner surface of the cover body (20, 55, 90), a holding portion (25, 57, 95) for fixing the position of the edge portion of the filter element (30, 60, 100) is formed so that both ends thereof coincide with the end portions of the groove portion (8, 80) formed on the case body (3, 72), and the peripheral edge of the filter element (30, 60, 100) is locked to the inside of the housing (2, 51, 71) by the groove portion (8, 80) and the holding portion (25, 57, 95).

The present invention is characterized in that in the above-described oil strainer, the cover body (20, 90) and the filter element (30, 100) are integrated as one member by the holding portion (25, 95).

In the above-described oil strainer, between the groove portion (8) of the case body (3, 72) and the peripheral edge of the filter element (30, 60, 100), there is formed a gap smaller than the dimension of the minimum dimension portion of a mesh hole forming a mesh (31, 61, 101) of the filter element (30, 60, 100).

The present invention may be configured so that in the above-described oil strainer, the cover body (55) and the filter element (60) are formed as separate members, and the holding portion is a groove portion (57) in which the edge portion of the filter element (60) is inserted therein. In this case, between the groove portion (8, 57) formed on the case body (3) and cover body (55) and the peripheral edge of the filter element (60), there is formed a gap (δ) smaller than the dimension of the minimum dimension portion of a mesh hole forming a mesh (61) of the filter element (60).

Also, in the present invention, in the peripheral edge portion (6a, 86) of the open portion (6, 85) formed on the case body (3, 72), the entire periphery thereof is formed in a state in which a member forming the case body (3, 72) is continuous and is closed in the peripheral direction.

In this case, the inflow portion (15, 94) and the outflow portion (16, 73) are provided on the case body (3, 72) independently of the open portion (6, 85) so that the state in which the peripheral edge portion (6a, 86) of the open portion (6, 85) is closed is maintained.

Also, the present invention is preferably configured so that in the above-described oil strainer, the housing (2, 51, 71) is formed so as to extend along one axis direction (X), the inflow portion (15, 94) is arranged on a first end side in the one axis direction (X), and the outflow portion (16, 73) is arranged on a second end side in the one axis direction (X); and the filter element (30, 60, 100) is arranged so as to extend in the one axis direction (X).

In this case, the oil strainer can be configured so that in the case body (72), partition portions (78, 79) formed by projecting opposed side surface portions (76) toward the center are provided on the inflow portion (94) side and the outflow portion (73) side in the one axis direction (X); the partition portion (78) on the inflow portion (94) side is formed by projecting one of the side surface portions (76) and the partition portion (79) on the outflow portion (73) side is formed by projecting the other of the side surface portions (76); the in flow portion (94) and the out flow portion (73) are provided on the outside of the partition portions (78, 79) with respect to the one axis direction (X); for the groove portion (80), the guide portions (81) are formed in parallel with each other in opposed portions in the one axis direction (X) of the partition portions (78, 79), and the locking portion (82) is formed so as to connect the guide portions (81) to each other; the interior of the case body (3, 72) is divided into the dirty space (D) and the clean space (C) in the width direction of the case body (3, 72) by the groove portion 80; and the inflow portion (94) communicates with the dirty space (D) going around the partition portion (78), and the outflow portion (73) communicates with the clean space (C) going around the partition portion (79).

According to the present invention, firstly, the oil strainer can be manufactured easily.

Specifically, since the groove portion is formed in the case body, when the filter element is placed in the case body, the positioning can be performed very easily. Also, since the groove portion is formed by the guide portion and the locking portion, the filter element can be inserted into the case body smoothly by the guide portion for guiding the filter element, and the inserted filter element is surely locked to the groove portion consisting of the locking portion and the guide portion.

Secondly, an oil strainer having a small manufacturing error and high quality can be obtained.

Specifically, the present invention uses a configuration such that the groove portion is provided in the housing, and the filter element is locked by this groove portion. Therefore, unlike the conventional system in which the filter element is held by the components of the housing as in the conventional oil strainer, a gap caused by the positional shift etc. of the filter element is not formed between the components of the housing.

Also, since the peripheral edge portion of the open portion formed on the case body is formed in a state of being closed throughout the entire periphery, the rigidity of the case body can be kept high. Because of the high rigidity, when the cover body is welded to the case body to assemble the oil strainer, deformation is less liable to occur. Thereby, an oil strainer with high accuracy can be formed. Also, because deformation is less liable to occur, measures against deformation need not be taken specially in the welding process, and welding work can be performed easily.

Also, after the case body and the cover body have been welded to each other, an airtightness test is conducted to check whether or not any poor weld is present. According to the present invention, the process of the airtightness test can be simplified, and the test accuracy can be increased. That is to say, the airtightness test is conducted by hermetically sealing the inflow portion and the outflow portion and by causing air to flow from either of the inflow portion and the outflow portion. In this case, the air inflow portion must be sealed. However, since the open portion is independent of the in flow portion and the out flow portion, the sealing condition does not exert an influence on the weld portion. Therefore, the presence of defect can be checked quickly. Even if a defect is present, the position of defect can be determined easily.

### BRIEF DESCRIPTION OF THE DRAWINGS

FIG. 1 is a perspective view of an oil strainer in accordance with a first embodiment of the present invention, in which the oil strainer is divided into components;

FIG. 2 is a plan view of a case body;

FIG. 3 is a plan view of a case body in accordance with a comparative example;

FIG. 4 is a view showing an assemblingprocess of an oil strainer;

FIG. 5 is a view showing one relationship between a frame portion of a filter element and a groove portion of a case body;

FIG. 6 is an enlarged view showing one example of mesh holes forming a mesh portion;

FIG. 7 is a perspective view of an oil strainer in accordance with a second embodiment of the present invention, in which the oil strainer is divided into components;

FIG. 8 is a longitudinal sectional view of an oil strainer in accordance with a third embodiment of the present invention;

FIG. 9 is a transverse sectional view of the oil strainer shown in FIG. 8; and

FIG. 10 is a plan view of a case body.

### DETAILED DESCRIPTION OF THE PREFERRED EMBODIMENTS

Embodiments of the present invention will now be described with reference to the accompanying drawings.

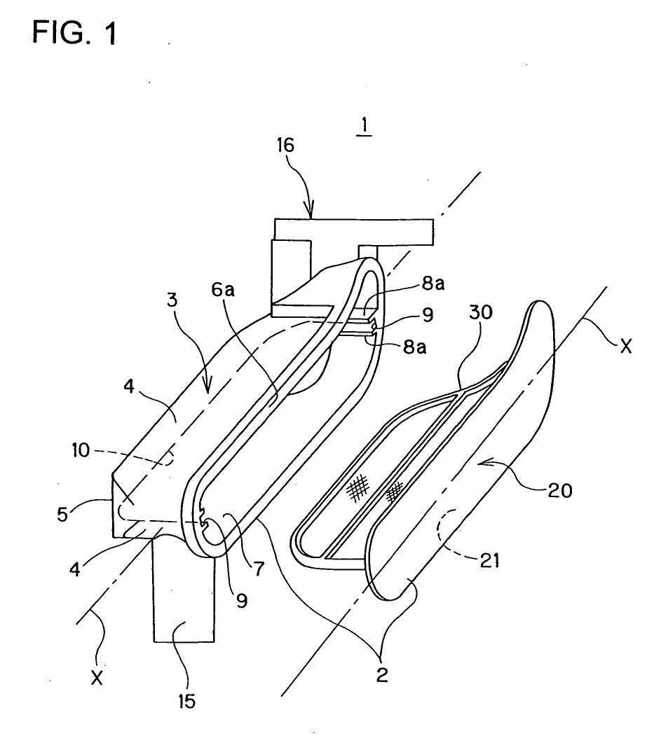

FIGS. 1 to 6 show an oil strainer 1 in accordance with a first embodiment of the present invention.

The oil strainer 1 includes a housing 2 that forms the outer shell of the oil strainer 1 and allows oil to flow therein and a filter element 30 disposed within the housing 2. The housing 2 is made up of a case body 3 formed of a resin material and a cover body 20 formed of a resin material. Also, the filter element 30 and the cover body 20 are formed as one member.

The case body 3 includes a side wall portion 4 and a bottom surface portion 5, and an open portion 6 is formed at the upper part of the case body 3. Also, the case body 3 is formed slenderly so as to extend in one axis direction X. The upper open portion 6 is formed so as to extend in one axis direction X corresponding to the shape of the case body 3.

Also, on the first end side in one axis direction X of the case body 3, an inflow portion 15 through which oil flows in is provided so as to project from the side wall portion 4 toward the outside, and on the second end side thereof, an outflow portion 16 allowing the filtered oil to flow out is provided.

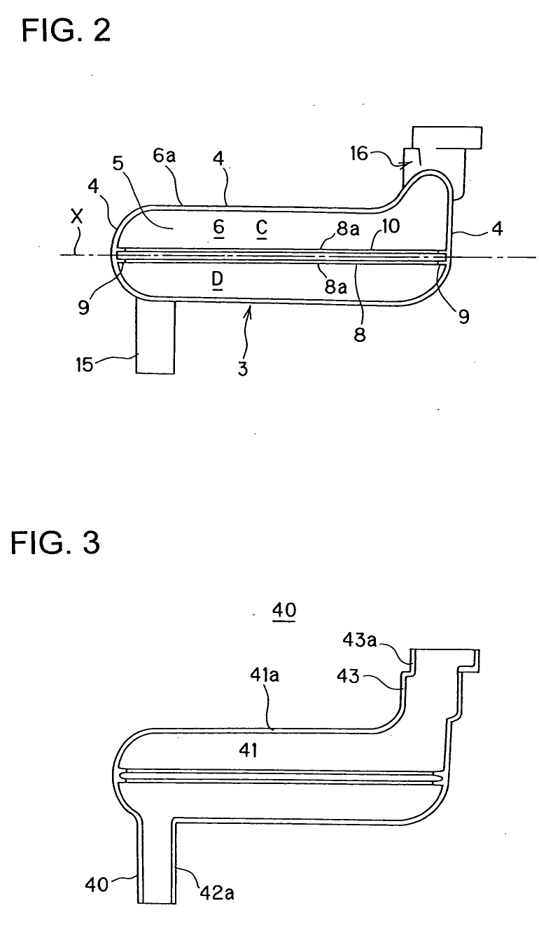

On an inner surface 7 of the case body 3, a groove portion 8 is formed in the side wall portion 4 and the bottom surface portion 5. As shown in FIG. 2, the groove portion 8 is formed with a pair of groove walls 8a extending in parallel with each other so as to project from the inner surface 7 of the case body 3 toward the inside of the case body 3. The groove portion 8 is formed along the inner surface 7 of the side wall portion 4 and the bottom surface portion 5 of the case body 3 so as to connect the first end side and the second end side in one axis direction X of a peripheral edge portion 6a of the open portion 6 to each other.

The groove portion 8 divides the interior of the case body 3 into the dirty side D on which the inflow portion 15 is disposed and the clean side C on which the outflow portion 16 is disposed. The inflow portion 15 and the outflow portion 16 are disposed on the dirty side D and the clean side C, respectively. By forming the case body 3 in this manner, the filter element 30 positioned on the inside of the groove portion 8 divides the interior of the housing 2 into the dirty side D on which the inflow portion 15 is disposed and the clean side C on which the outflow portion 16 is disposed.

Also, the peripheral edge portion 6a of the open portion 6 of the case body 3 is formed so as to be made continuous by a member forming the side wall portion 4 throughout the entire periphery in a state of being closed in the peripheral direction. In order to make the peripheral edge portion 6a of the open portion 6 in the closed state in this manner, in the case body 3, both of the inflow portion 15 and the outflow portion 16 are provided under the open portion 6 independently of the open portion 6.

It is assumed that, like a case body 40 shown in FIG. 3, an open portion 41 is formed continuously with an inflow portion 42 and an outflow portion 43, and an open portion for connecting the inside and outside of the case body 40 to a peripheral edge portion 42a is provided. In this case, the rigidity of the case body 40 decreases significantly. The decrease in rigidity easily produces a strain and makes it very difficult to finish the case body and the cover body to the designed size. Therefore, at the time of welding, the accuracy of the joint portion of the case body and the cover body decreases, which hinders the manufacture of a high-quality product. Also, in the welding process, the case body and the cover body may be deformed. This deformation also leads to the degradation of quality.

On the other hand, as shown in FIG. 1, the cover body 20 is formed so as to have an external shape that is the same as the shape of the open portion 6 formed on the case body 3. The peripheral edge of the cover body 20 coincides with the peripheral edge portion 6a of the open portion 6 of the case body 3, so that by lapping the cover body 20 on the peripheral edge portion 6a of the open portion 6, the open portion 6 of the case body 3 is closed. Also, the cover body 20 is formed with the filter element 30 integrally. The filter element 30 extends from an inner surface 21 of the cover body 20 perpendicularly to the cover body 20 in the center in the width direction of the cover body 20.

The filter element 30 includes a mesh portion 31 that allows oil to pass through and filters out impurities contained in the oil and a frame portion 32 surrounding the periphery of the mesh portion 31. Also, the filter element 30 is provided with a center rib 33, extending in parallel with the cover body 20, at a substantially central position in the height direction. The shape of the frame portion 32 maybe formed individually so as to correspond to the shapes of the bottom surface portion 5 and the side wall portion 4 of the case body 3.

The cover body 20 with which the filter element 30 is integrated may be formed as one member by injection molding both of the filter element 30 and the cover body 20, or may be formed by welding one side of the frame portion 32, forming the filter element 30, to the inner surface 21 of the cover body 20 after the filter element 30 and the cover body 20 have been formed separately. For both of the above modes, a boundary portion between the filter element 30 and the cover body 20 functions as a position holding portion 25 in which the position of the filter element 30 is fixed with respect to the cover body 20.

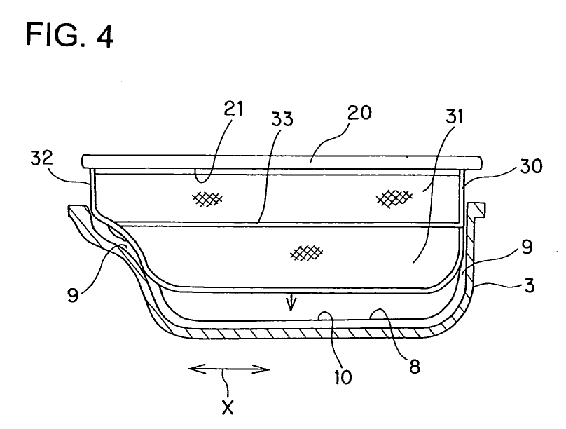

For the oil strainer 1 having the above-described construction, as shown in FIG. 4, the filter element 30 is inserted into the case body 3 so that the frame portion 32 of the filter element 30 is positioned on the inside of the groove portion 8, by which the open portion 6 of the case body 3 is closed by the cover body 20. At this time, the groove portion 8 formed in the side wall portion 4 functions as a guide portion 9 for guiding the filter-element 30 to the bottom surface portion 5 of the case body 3 while the positional shift of the filter element 30 is prevented. Also, the groove portion 8 formed in the bottom surface portion 5 functions as a locking portion 10 for locking the filter element 30. Needless to say, the groove portion 8 formed in the side wall portion 4 also functions as a locking portion for inhibiting the positional shift of the filter element 30.

After the open portion 6 of the case body 3 has been closed by the cover body 20, the peripheral edge of the cover body 20 and the upper end edge of the case body 3 are welded to each other to complete the oil strainer 1. Although the welding method is not subject to any special restriction, the ultrasonic welding process is preferably used.

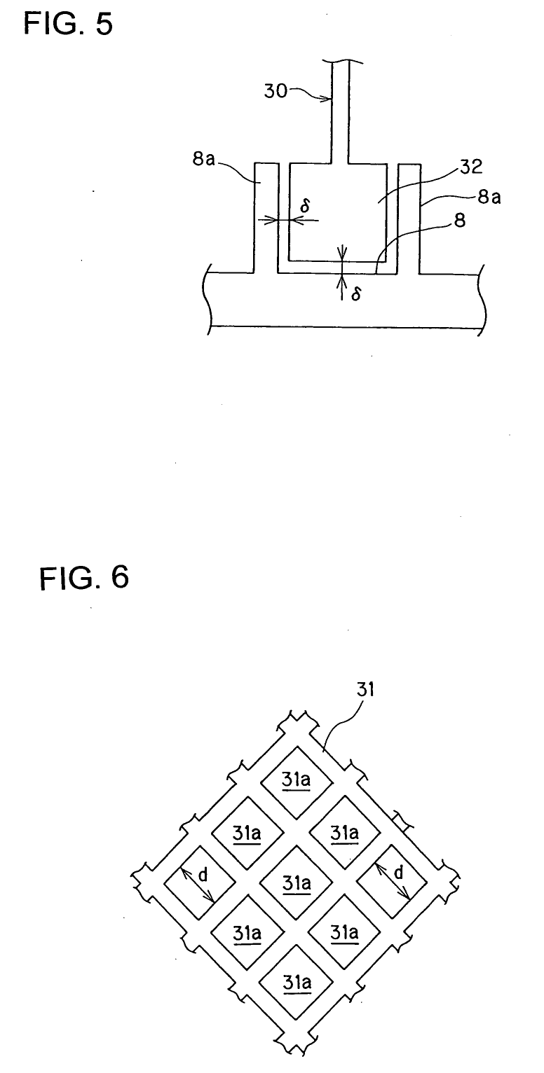

In the completed oil strainer 1, as shown in FIG. 5, a predetermined gap δ is formed between the groove portion 8 of the case body 3 and the frame portion 32 of the filter element 30. This gap δ smoothly moves the filter element 30 in the groove portion 8, functioning as the guide portion 9, of the side wall portion 4 of the case body 3. Also, the flatness of the groove portion 8 of the case body 3 and hence the filter element 30 and the perpendicularity of the filter element 30 with respect to the cover body 20 have errors inevitably. Due to the formation of the gap δ between the frame portion 32 and the groove portion 8, the gap δ functions as a relief for the filter element 30 with respect to the groove portion 8. Thereby, an unnecessary stress is prevented from being produced in the filter element 30.

The dimension of the gap δ is made smaller than the dimension d of the minimum dimension portion of a mesh hole 31a of the mesh portion 31. For example, in the case where the mesh hole 31a is formed into a square shape as shown in FIG. 6, the minimum dimension portion of a mesh hole 31a is the dimension d between the opposite sides. The gap δ formed between the frame portion 32 and the groove portion 8 is formed so as to be smaller than the dimension d between the opposite sides.

If the sum of both gaps formed between each surface of the frame portion 32 and each groove wall 8a of the groove portion 8 is smaller than the dimension d, even in the case where the filter element 30 is shifted to the one groove wall 8a side, the intrusion itself of impurities into the groove portion 8 can be prevented. Naturally, the gap between the bottom portion of the groove portion 8 and the frame portion 32, the gap being made smaller than the dimension d, prevents impurities from passing between the bottom portion of the groove portion 8 and the frame portion 32 even if the impurities intrude into a portion between the groove wall 8a and the frame portion 32.

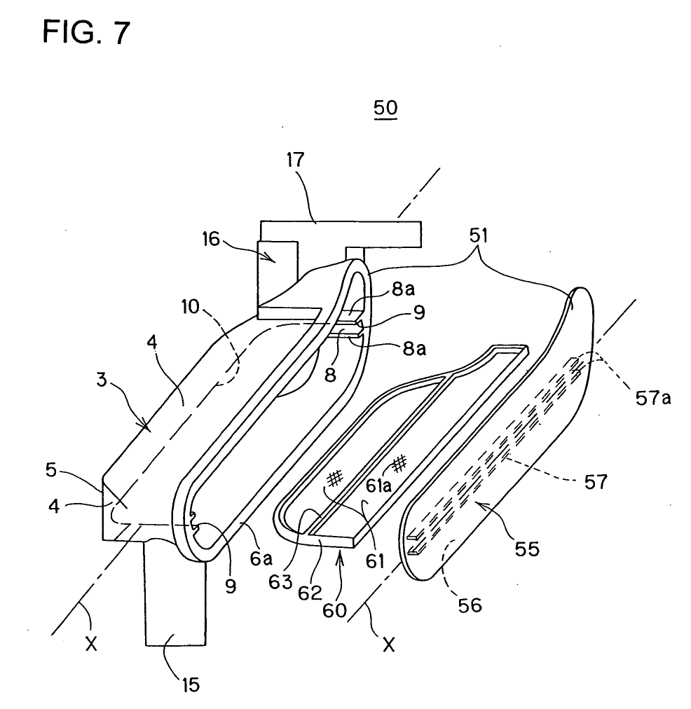

Next, an oil strainer 50 in accordance with a second embodiment of the present invention is described with reference to FIG. 7.

In the oil strainer 50, a housing 51 forming the outer shell of the oil strainer 50 is made up of a case body 3 and a cover body 55, and the cover body 55 and a filter element 60 are formed as separate members. The construction of the case body 3 is the same as that of the case body 3 in accordance with the first embodiment. Herein, the same symbols are applied to the elements of the case body 3 that are equivalent to those in the first embodiment, and the explanation thereof is omitted.

The cover body 55 is formed into a plate shape, and on the inner surface 56 side thereof, a groove portion 57 is formed in the center in the width direction thereof. The groove portion 57 extends along the above-described one axis direction X in which the housing 51 extends, and is formed so as to connect both end portions in one axis direction X of the cover body 55 to each other. In the groove portion 57 as well, a pair of opposed groove walls 57a are formed in parallel with each other.

On the other hand, the filter element 60, consisting of a plurality of mesh holes 61a, includes a mesh portion 61 that allows oil to pass through and filters out impurities and a frame portion 62 provided so as to surround the periphery of the mesh portion 61. Also, a center rib 63 extending in one axis direction X is provided at a substantially central position in the height direction.

In the oil strainer 50 having the above-described construction in accordance with the second embodiment, one side 62a of the frame portion 62 of the filter element 60 is inserted into the groove portion 57 formed on the cover body 55, and other side portions and the lower portion are inserted into a groove portion 8 formed on the inner surface of the case body 3. Then, an open portion 6 formed at the upper part of the case body 3 is closed by the cover body 55, and the peripheral edge of the coverbody 55 and a peripheral edge portion 6a at the upper part of the case body 3 are welded to each other. Thereby, the oil strainer 50 is completed.

The oil strainer 50 in accordance with the second embodiment is formed so that when the open portion 6 of the case body 3 is closed by the cover body 55, both ends in one axis direction X of the groove portion 57 formed on the cover body 55 coincide with the upper ends of the groove portion 8 formed in a side wall portion 4 of the case body 3. Also, in the oil strainer in accordance with the second embodiment, a predetermined gap δ may also be formed between the groove portion 57 of the cover body 55 and the frame portion 62.

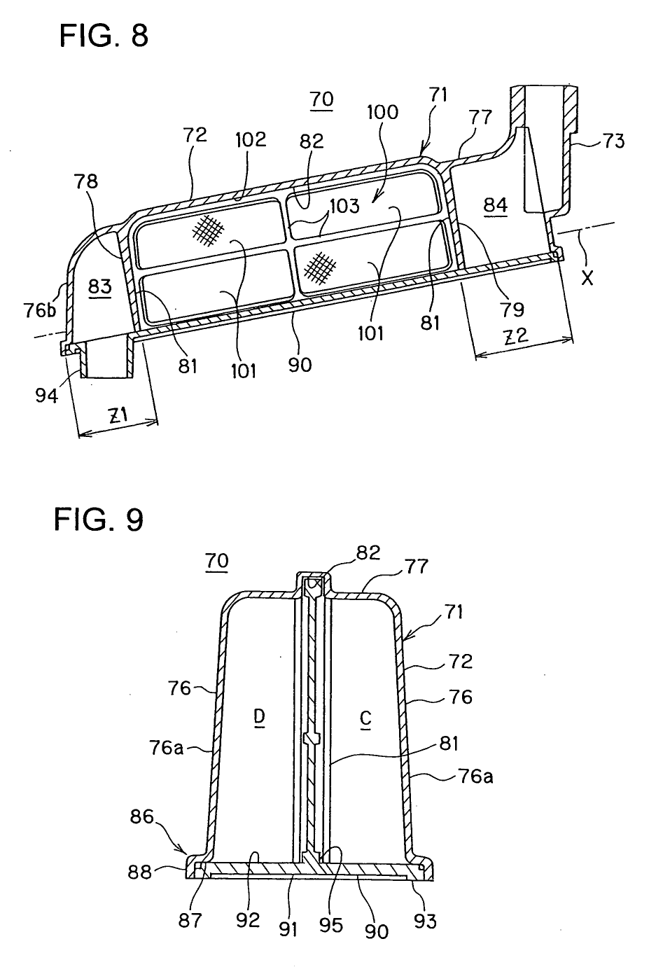

Next, a third embodiment is described with reference to FIGS. 8 to 10.

An oil strainer 70 in accordance with the third embodiment also includes a housing 71 forming the outer shell of the oil strainer 70 and a filter element 100 disposed within the housing 71. The housing 71 is made up of a case body 72 formed with an open portion 85 and a cover body 90 for closing the open portion 85. This oil strainer 70 is also formed slenderly so as to extend in one axis direction X.

The case body 72 is made up of a peripheral wall portion 76 and a top surface portion 77, and the open portion 85 is formed on the bottom surface thereof. The first end side in one axis direction X is closed by the peripheral wall portion 76, and on the other hand, the second end side is provided with an outflow portion 73 for allowing oil having passed through the housing 71 and having been filtered to flow out. Also, in the case body 72, partition portions 78 and 79 projecting from one side surface portion 76a of the peripheral wall portion 76 toward the other opposed side surface portion 76a are formed. The partition portions 78 and 79 are formed at positions slightly on the inside from both ends in one axis direction X.

Between the partition portions 78 and 79, a groove portion 80 for locking the filter element 100 is formed. The groove portion 80 is formed continuously in a portion between the partition portions 78 and 79, of the opposed surfaces of the partition portions 78 and 79 and the inner surface of the top surface portion 77. A groove portion 81 in the partition portion 78, 79 is formed so as to extend vertically in the partition portion 78, 79 by recessing a part of the partition portion 78, 79 into a concave shape. On the other hand, a groove portion 82 formed in the top surface portion 77 of the case body 72 is formed by projecting the central portion in the width direction of the case body 72 to the outside along the one axis direction X.

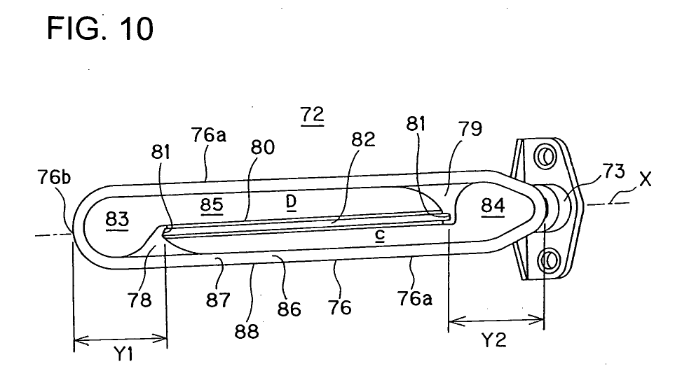

Further, in the case body 72, space portions 83 and 84 are formed on the outside of the partition portions 78 and 79, respectively, in one axis direction X. Of these space portions, the space portion 83 on the first end side in one axis direction X is connected to an inflow portion 94 provided in the cover body 90, and the space portion 84 on the outflow portion 73 side forming the second end side is connected to the outflow portion 73. As is apparent from FIG. 10, the space portion 83 on the inflow portion 94 side communicates with the upper range only with the groove portion 80 being a boundary, and is separated from the lower range by the partition portion 78. On the other hand, the space portion 84 on the outflow portion 73 side communicates with the lower range only with the groove portion 80 being a boundary, and is separated from the upper range by the partition portion 79. Thus, the groove portion 80 divides the interior of the case body 72 into the dirty side D on which the inflow portion 94 is disposed and the clean side C on which the outflow portion 73 is disposed. The inflow portion 94 communicates with the dirty side D going around the partition portion 78 via the space portion 83, and the outflow portion 73 communicates with the clean side C going around the partition portion 79 via the space portion 84.

In the case body 72 as well, a peripheral edge portion 86 of the open portion 86 is continuous throughout the entire periphery and is in a state of being closed. As shown in FIG. 9, the peripheral edge portion 86 includes a contact surface 87 projecting from the peripheral wall portion 76 toward the outside at the lower end of the case body 72 and an outer peripheral wall 88 projecting further toward the downside at the outer peripheral edge of the contact surface 87.

On the other hand, the cover body 90 is formed into a plate shape, and the external shape thereof is the same as the shape of the open portion 85 formed on the case body 72. The cover body 90 is inserted into the inside of the outer peripheral wall 88 forming the peripheral edge portion 86 of the open portion 85 of the case body 72, and is lapped on the contact surface 87 forming the peripheral edge portion 86, by which the open portion 85 of the case body 72 is closed.

On the first end side in one axis direction X of the cover body 90, the inflow portion 94 extending from an outer surface 91 of the cover body 90 is formed. The inflow portion 94 is allowed to communicate with the space portion 83 formed in the case body 72 when the cover body 90 closes the open portion 85 of the case body 72 and is integrated with the case body 72.

Also, the cover body 90 is integrally formed with the filter element 100. The filter element 100 extends from an inner surface 92 of the cover body 90 at right angles to the cover body 90 in the center in the width direction of the cover body 90. Both ends of the filter element 100 are arranged at the inside positions separating predetermined distances Z1 and Z2 from both ends in one axis direction X. The predetermined distances Z1 and Z2 correspond to the distances Y1 and Y2 between both ends in one axis direction X of the case body 72 and guide portions 81 formed in the partition portions 78 and 79 (refer to FIG. 10), and the length of the filter element 100 corresponds to the distance between the guide portions 81. The filter element 100 includes a mesh portion 101, a frame portion 102 surrounding the periphery of the mesh portion 101, and a center rib 103 provided in a cross shape. The process for the integration can be performed in the same way as in the first embodiment.

For the oil strainer 70 having the above-described construction as well, the frame portion 102 of the filter element 100 is positioned on the inside of the groove portion 80 of the case body 72. The groove portion 80 formed in the partition portion 78, 79 functions as a guide portion for guiding the filter element 100 from the open portion 85 side to the top surface portion 77 of the case body 72. Also, the groove portion 80 in the top surface portion 77 functions as a locking portion, and thus the filter element 100 is locked to this groove portion 80. In the oil strainer 70 of this embodiment as well, a gap smaller than the dimension of the minimum dimension portion of a mesh hole is formed between the frame portion 102 of the filter element 100 and the groove portion 80. Also, the case body 70 and the cover body 90 are welded to each other by ultrasonic welding etc.

In the oil strainer in accordance with the third embodiment, both ends of the filter element 100 are locked to the groove portions 80 formed in the partition portions 78 and 79 as guide portions 81. Therefore, as compared with the case where the groove portion 80 is provided directly on the case body 72, the oil strainer 70 has a construction that is less liable to transmit vibrations to the filter element 100, and hence is invulnerable to vibrations.

Also, for this third embodiment as well, the cover body and the filter element may be provided as separate members. In this case, a groove portion in which the frame portion of the filter element is inserted is formed on the inner surface of the cover body. The groove portion formed on the cover body is formed so that both ends thereof coincide with the upper ends of the groove portions formed in the partition portion of the case body.

In the above-described embodiments, the oil strainer having the cover body formed into a plate shape has been explained as an example. However, the shape of cover body is not limited to this shape. A cover body having an arcuate transverse cross section may be used. Also, the example in which the groove portion is formed continuously in the extension direction thereof has been explained. However, since the gap formed between the frame portion of the filter element and inside surfaces of the case body and cover body is formed so as to be smaller than the minimum dimension of the mesh hole, a break may be provided at an intermediate position of the groove portion, or the groove portion may be formed intermittently.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2006-011511 filed on Jan. 19, 2006 including the specification, claims, drawings and summary is incorporated herein by reference in its entirety.

1. An oil strainer comprising:
a housing which is formed by a case body formed with an open portion and a cover body which closes the open portion of the case body, and allows oil to flow therein;
a filter element disposed in the housing to filter oil flowing in the housing; and
an inflow portion through which oil flows into the housing and an outflow portion through which the oil having flown in the housing flows out,
wherein in the case body, there is provided a groove portion including a guide portion for guiding the filter element to an inside of the case body by inserting both side edges of the filter element into an inside and a locking portion for locking the filter element having been guided by the guide portion by inserting a tip end edge in an insertion direction of the filter element into the inside;
the groove portion is formed along an inner peripheral surface of the case body from one portion of a peripheral edge portion of the open portion to the other portion thereof, and divides an interior of the case body into a dirty side on which the inflow portion is disposed and a clean side on which the outflow portion is disposed; and
on an inner surface of the cover body, a holding portion for fixing a position of an edge portion of the filter element is formed so that both ends thereof coincide with end portions of the groove portion formed on the case body, and a peripheral edge of the filter element is locked to an inside of the housing by the groove portion and the holding portion.

2. The oil strainer according to claim 1, wherein the cover body and the filter element are integrated as one member by the holding portion.

3. The oil strainer according to claim 1, wherein between the groove portion of the case body and the peripheral edge of the filter element, there is formed a gap smaller than a dimension of a minimum dimension portion of a mesh hole forming a mesh of the filter element.

4. The oil strainer according to claim 1, wherein the cover body and the filter element are formed as separate members, and the holding portion is a groove portion in which the edge portion of the filter element is inserted therein.

5. The oil strainer according to claim 4, wherein between the groove portion formed on the case body and cover body and the peripheral edge of the filter element, there is formed a gap smaller than a dimension of a minimum dimension portion of a mesh hole forming a mesh of the filter element.

6. The oil strainer according to claim 1, wherein in the peripheral edge portion of the open portion formed on the case body, an entire periphery thereof is formed in a state in which a member forming the case body is continuous and is closed in a peripheral direction.

7. The oil strainer according to claim 6, wherein the inflow portion and the outflow portion are provided on the case body independently of the open portion so that the state in which the peripheral edge portion of the open portion is closed is maintained.

8. The oil strainer according to claim 1, wherein the housing is formed so as to extend along one axis direction, the inflow portion is arranged on a first end side in the one axis direction, and the outflow portion is arranged on a second end side in the one axis direction; and
the filter element is arranged so as to extend in the one axis direction.

9. The oil strainer according to claim 2, wherein between the groove portion of the case body and the peripheral edge of the filter element, there is formed a gap smaller than a dimension of a minimum dimension portion of a mesh hole forming a mesh of the filter element.
